(19) United States
(12) Patent Application Publication
(10) Pub. No.: US 2008/0123951 A1
(43) Pub. Date: May 29, 2008

(54) Image processing method

(75) Inventors: Jyun-Sian Li, Tainan (TW); Shin-Tai Lo, Miaoli (TW); Ruey-Shing Weng, Kaohsiung (TW); Ching-Fu Hsu, Taichung (TW)

Correspondence Address: BACON & THOMAS, PLLC, 625 SLATERS LANE, FOURTH FLOOR, ALEXANDRIA, VA, 22314, US

(73) Assignee: Wintek Corporration, Taichung (TW)

(21) Appl. No.: 11/979,759

(22) Filed: Nov. 8, 2007

(30) Foreign Application Priority Data
Nov. 13, 2006 (TW) 95141939

(51) Int. Cl. H04N 1/62

(52) U.S. Cl. 382/167

(57) ABSTRACT

An image processing method used for enhancing the color saturation of an image is provided. The image comprises a pixel with a pixel data, wherein the pixel data has the data of three colors. The image processing method comprises the steps stated below. Firstly, a color purity of the pixel is calculated and a corresponding scale factor is generated according to the color purity, wherein the color purity is the difference between the maximum grayscale value and the minimum grayscale value of the data of the three colors. Then, a processed pixel data is generated according to an enhancement matrix and the pixel data, wherein the enhancement matrix is determined by the scale factor.

This application claims the benefit of Taiwan application Serial No. 95141939, filed Nov. 13, 2006, the subject matter of which is incorporated herein by reference.

### BACKGROUND OF THE INVENTION

1. Field of the Invention

The invention relates in general to an image processing method, and more particularly to an image processing method for color enhancement.

2. Description of the Related Art

With the development of the third generation (3G) communication technology, many 3G mobile communication devices such as mobile phone and personal digital assistant (PDA) are often also used for receiving and displaying digital images, so that users can watch the digital images displaying while operating the mobile communication devices. The color saturations of the digital images came from a charge couple device (CCD) or shown by a pocket TV are usually insufficient. Therefore, how to display images with saturated color on the display screens of the above communication devices has become a focus for many manufacturers.

In order to optimize the exhibition of an image, several image processing methods have been provided to enhance the color saturation of an image. A patent entitled “Automatic Color Saturation Enhancement” is disclosed in the U.S. Pat. No. 6,771,311. According to the patent, four predictors are obtained first, and the scale factor is calculated next. As the method requires very complicated mathematical operation, when it's applied in a driver IC, it costs higher price.

Besides, a patent entitled “Adaptive Pixel-Level Color Enhancement For A Digital Camera” is disclosed in the U.S. Pat. No. 6,721,000. The patent processes the color components of the YUV color model. The U component and the V component are multiplied by a scale factor to enhance the color saturation. However, if the pixels with high color saturation are enhanced by the method, the grayscale values of those pixels will be even higher than a maximum grayscale value (normally 255). Under such circumstance, those pixels are displayed according to the maximum grayscale value, which results in the occurrence of clipping. As a result, the image on display will lose some subtle information of the original image, and the original color level of those pixels could not be truly shown.

According to the paper entitled “More Realistic Colors From Small-Gamut Mobile Displays” presented by the Philips Research Laboratories in the society for information display (SID) 2004, a post processing method capable of reducing the occurrence of “clipping” is provided. The technology is directed to the situations when the grayscale values of pixels to be processed are greater than the maximum grayscale value, and the grayscale values of the pixels to be processed are smaller than the minimum grayscale value (such as 0). A white color is added to the whole image to make the grayscale values of the whole image's pixels greater than or equal to 0, and then the grayscale values of the image are normalized by the maximum grayscale value of those pixels to make the grayscale values of the whole image smaller than or equal to 255. The method does not affect the hue of the image, but the color saturation of the image is decreased.

### SUMMARY OF THE INVENTION

The invention is directed to an image processing method with space adoption. An enhancement matrix of a pixel of an image is generated according to the color purity of the pixel, and then the grayscale value of the pixel is adjusted accordingly. The color enhancement for each pixel of the image is different. A pixel with small color purity is enhanced more largely than a pixel with high color purity. The clipping is effectively resolved without changing the original hue of the image.

According to a first aspect of the present invention, an image processing method for enhancing the color saturation of an image is provided. The image has a pixel with a pixel data, wherein the pixel data includes the data of three colors. The image processing method comprises the steps stated below. Firstly, a color purity of the pixel is calculated and a corresponding scale factor is generated according to the color purity, wherein the color purity is the difference between the maximum grayscale value and the minimum grayscale value of the three colors data. Then, a processed pixel data is generated according to an enhancement matrix and the pixel data, wherein the enhancement matrix is determined by the scale factor.

The invention will become apparent from the following detailed description of the preferred but non-limiting embodiments. The following description is made with reference to the accompanying drawings.

### BRIEF DESCRIPTION OF THE DRAWINGS

FIG. 1 is a flowchart of an image processing method according to a preferred embodiment of the invention;

FIG. 2 is a CIE standard chromatic diagram;

Appended Drawing 1A is a first color image;

Appended Drawing 1B is a CIE 1931 chromaticity coordinate distribution diagram of the image of Appended Drawing 1A;

Appended Drawing 2A is an adjusted image of the first color image of Appended Drawing 1A after image processing;

Appended Drawing 2B is a CIE 1931 chromaticity coordinate distribution diagram of the image of Appended Drawing 2A;

Appended Drawing 3A is a second color image.

Appended Drawing 3B is a CIE 1931 chromaticity coordinate distribution diagram of Appended Drawing 3A;

Appended Drawing 4A is an adjusted image of the second color image of Appended Drawing 3A after image processing; and

Appended Drawing 4B is a CIE 1931 chromaticity coordinate distribution diagram of the image of Appended Drawing 4A.

### DETAILED DESCRIPTION OF THE INVENTION

The image processing method of the invention is used for enhancing the color saturation of an image. The image includes at least a pixel and a pixel data corresponding to the pixel. The pixel data that includes the data of three colors, namely red, green and blue, is denoted by (C1, C2, C3), wherein C1 is the grayscale value of the red data, C2 is the grayscale value of the green data, and C3 is the grayscale value of the blue data.

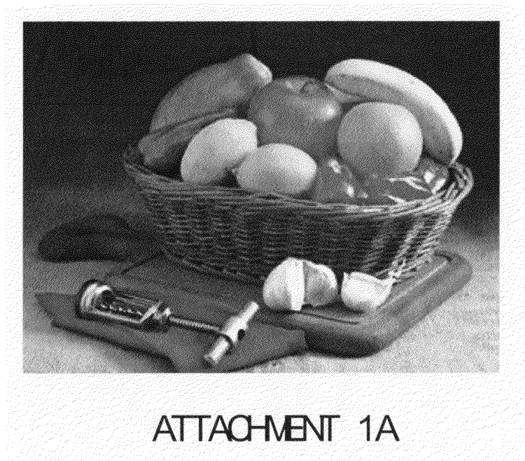

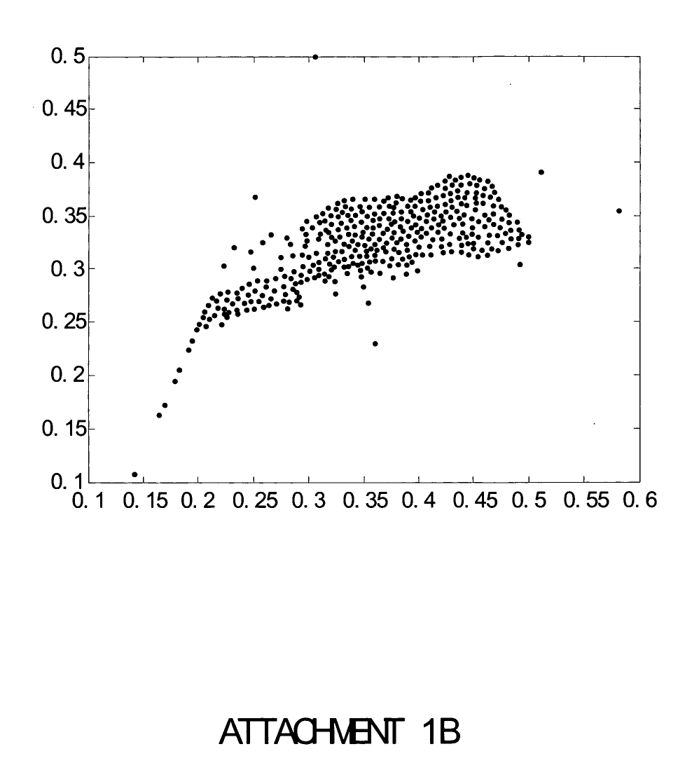

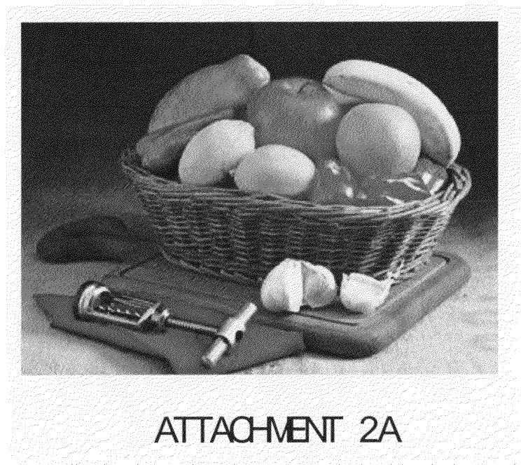

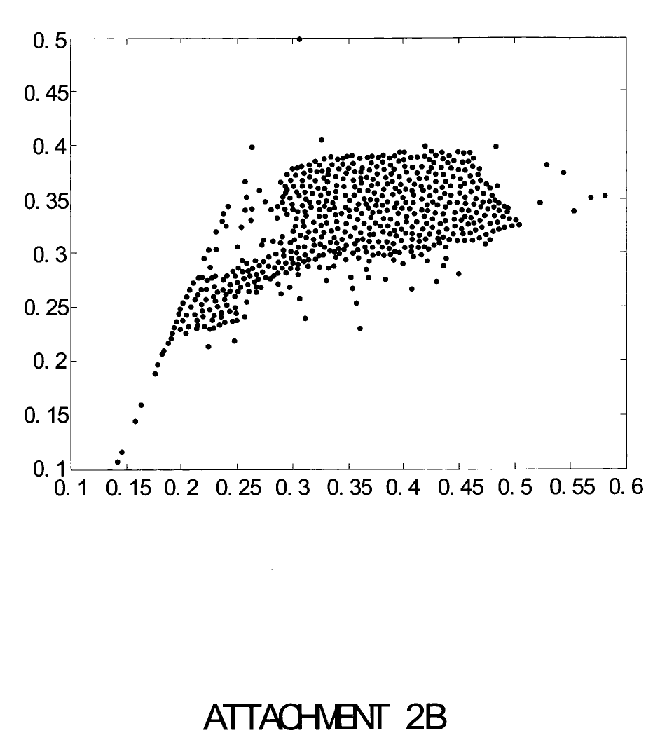

Referring to FIG. 1, a flowchart of an image processing method according to a preferred embodiment of the invention is shown. As indicated in FIG. 1, the image processing method comprises steps 11˜13. Firstly, a color purity of a pixel is calculated according to a pixel data (C1, C2, C3) of the pixel, and a corresponding scale factor is determined according to the color purity. Next, an enhancement matrix of the pixel is generated by the scale factor, and a processed pixel data is generated according to the enhancement matrix and the pixel data.

The method begins at step 11. A color purity of the pixel is calculated according to the pixel data of the pixel. In this step, the color grayscale values of each pixel of the image are inputted for analysis, and the color purity of each pixel is calculated according to the color grayscale values of each pixel. Let the pixel data (C1, C2, C3) be taken for example. The color purity is obtained according to the formula:

cp=max(C1, C2, C3)−min(C1, C2, C3),

wherein, cp is the color purity, max(C1, C2, C3) is the maximum grayscale value among C1, C2 and C3, and min(C1, C2, C3) is the minimum grayscale value among C1, C2 and C3. The color purity is defined as the difference between the maximum grayscale value and the minimum grayscale value of C1, C2 and C3.

The values of the color purity of the pixels can be divided into several scales, and the degree of enhancement for each pixel is determined according to the above scales. The higher the calculated color purity is, the more likely the pixel will display a specific color. For example, let one particular pixel with pixel data (C1, C2, C3) be expressed below, wherein C1 is equal to 18, C2 is equal to 165, and C3 is equal to 80, then max (C1, C2, C3) is equal to C2, and min (C1, C2, C3) is equal to C1, so cp is equal to 147. As defined above that C1 is the grayscale value of the red data, C2 is the grayscale value of the green data, the pixel is most likely to display a green color. The steps of the image processing method of the invention continue as below.

Next, the method proceeds to step 12, a corresponding scale factor is generated according to the color purity. The scale factor is used for determining how much the color saturation of a pixel will be enhanced. After a color purity of the pixel is determined, a scale factor of the pixel is further determined according to the cp value. The values of the color purity can be divided into n scales, and the value of the scale factor is s. Preferably, a color purity of each scale corresponds to a scale factor. Because almost every pixel has different value of color purity, the degree of enhancement varies accordingly.

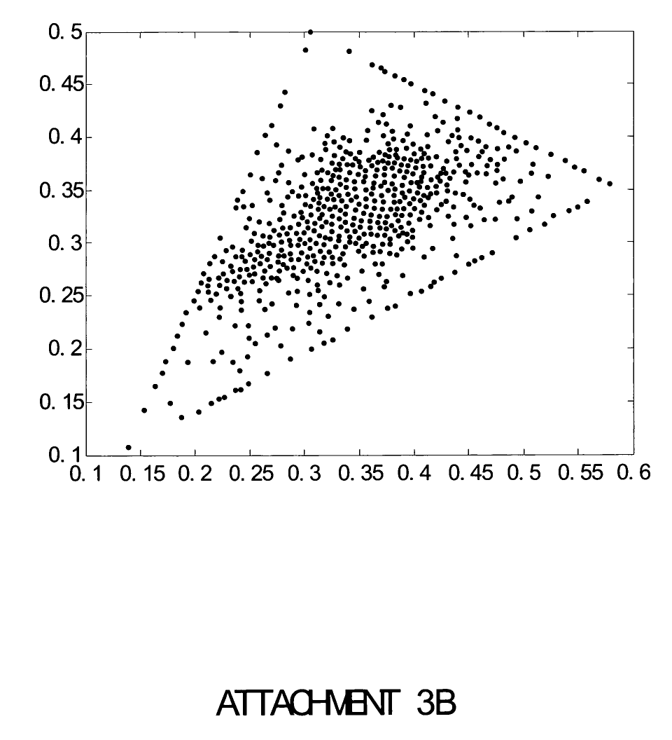

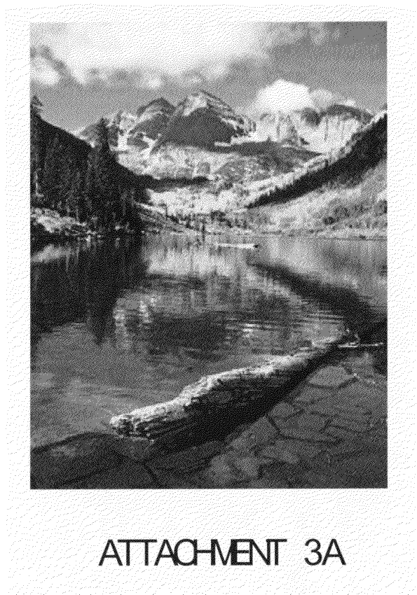

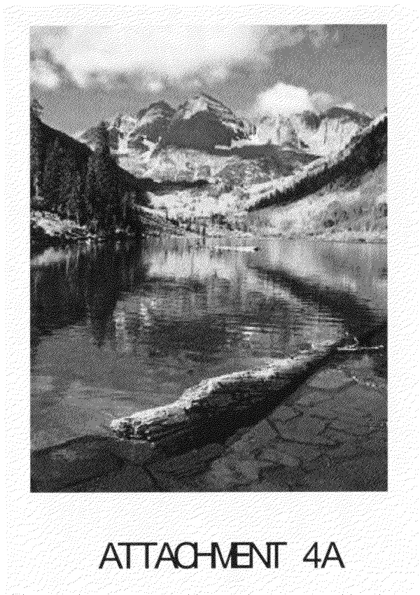

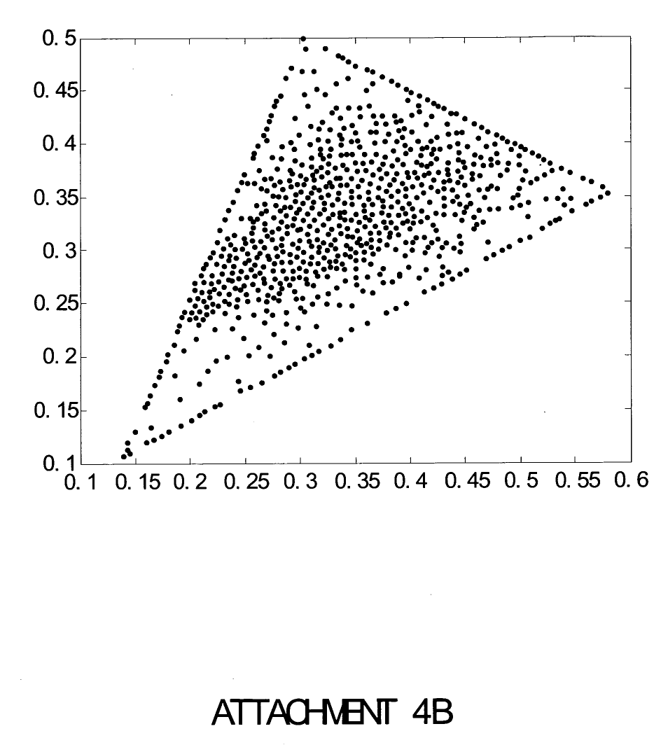

Elaborated by FIG. 2, a CIE standard chromatic diagram is shown. In FIG. 2, the triangle region T denotes the range of colors that are exhibited on a display, and the points P₁ and P₂ correspond to two different pixels, wherein the pixel of the point P₁ has higher color purity and is more likely to display a green color, and the pixel of the point P₂ has smaller color purity and is more likely to display a white color. As the pixel of the point P₁ has higher color purity, there is no need to largely enhance the color saturation; therefore the scale factor of the point P₁ is set to a smaller value. As the pixel of the point P₂ has smaller color purity, the color saturation can be largely enhanced; therefore the scale factor of the point P₂ is set to a higher value.

The method for obtaining the scale factor includes the following steps. A Query Table for generating the scale factor according to color purity is provided. Preferably, the Query Table has a number of numeric pairs (Gi, Si), and the number of numeric pairs is the number of scales, which is n. Let i=1˜n, and let each numeric pair have a lower limit Gi and a corresponding factor Si. The lower limit Gi is for determining the scale for the color purity of each pixel, and the corresponding factor Si is set as the value of the scale factor of the pixel, wherein the lower limit Gi ranges from a minimum grayscale value (normally 0) to a maximum grayscale value (normally 255), and the factor Si ranges from 0 to 1.

The numeric pairs at least comprise two numeric pairs, such as a first numeric pair and a second numeric pair. The first numeric pair comprises a first lower limit and a corresponding first factor, and the second numeric pair comprises a second lower limit and a corresponding second factor, wherein the first lower limit is greater than the second lower limit, and the first factor is smaller than the second factor. In other words, the lower limits of the numeric pairs are decreasing and the corresponding factors are increasing in the Qurey Table. That is, the greater the lower limits, the smaller the corresponding factors are; the smaller the lower limits, the greater the corresponding factors are. As indicated in the Query Table I, the values of the color purity are divided into 13 scales (n=13), for example.

Query Table I

| Numeric Pair (i) | Lower Limit (Gi) | Factor (Si) |
|---|---|---|
| 1 | 178 | 0 |
| 2 | 162 | 0.05 |
| 3 | 146 | 0.10 |
| 4 | 130 | 0.15 |
| 5 | 114 | 0.20 |
| 6 | 98 | 0.25 |
| 7 | 82 | 0.30 |
| 8 | 66 | 0.35 |
| 9 | 50 | 0.40 |
| 10 | 34 | 0.45 |
| 11 | 18 | 0.50 |
| 12 | 8 | 0.55 |
| 13 | 0 | 0.60 |

Likewise, the pixel data (C1, C2, C3) is also exemplified by (18, 165, 80). When the color of the pixel is to be enhanced, the color purity must be calculated first. According to the above definition, the color purity cp is 147. Next, the scale factor of the pixel is determined according to the color purity cp and the Query Table I. Preferably, the first lower limit G1 is set as the maximum lower limit, that is, the first numeric pair (178, 0) of the Query Table I. The step is stated below:
(a) Firstly, whether the color purity is greater than or equal to the first lower limit is determined: if the color purity is greater than or equal to the first lower limit, then the scale factor is the first factor corresponding to the first lower limit; if the color purity is smaller than the first lower limit, then the method proceeds to the next step;
(b) Next, whether the color purity is greater than or equal to the lower limit of the next numeric pair is determined: if the color purity is greater than or equal to the lower limit of the next numeric pair, then the scale factor is the factor corresponding to the next numeric pair; if the color purity is smaller than the lower limit of the next numeric pair, then the method proceeds to the next step;
(c) Repeat step (b) until the scale factor is obtained.

For example, the color purity cp in the above example being 147 is smaller than the first lower limit that is 178, so the method continues to determine whether the value of the color purity cp is greater than or equal to the lower limit of the next numeric pair. As indicated in the Query Table I, the next numeric pair is the second numeric pair (162, 0.05). The value of the color purity cp is still smaller than 162, so the method continues to check the next numeric pair (146, 0.10) until the color purity is greater than or equal to the lower limit of the next numeric pair. In the above example, when the third numeric pair (146, 0.10) is checked, as 147 is greater than 146, the factor 0.10 of the third numeric pair is determined as the value for the scale factor s of the pixel, that is, s is equal to 0.10.

After the scale factor of the pixel is determined, as indicated in FIG. 1, the method proceeds to step 13, the enhancement matrix is determined by the scale factor, and a processed pixel data is generated according to the enhancement matrix and the pixel data. According to the scale factor s of the inputted value, the enhancement matrix with different levels of enhancement is generated for enhancing the color saturation of the pixels with different values of color purity. The enhancement matrix is defined as below:

$$E = [ \begin{matrix}1 + s & - s / 2 & - s / 2 \\ - s / 2 & 1 + s & - s / 2 \\ - s / 2 & - s / 2 & 1 + s\end{matrix} ] \qquad ( 1 )$$

Wherein E is the enhancement matrix, and s is the scale factor. The processed pixel data (C1′, C2′, C3′) is generated by multiplying the enhancement matrix E by the pixel data (C1, C2, C3), and the matrix multiplication is expressed below:

$$[ \begin{matrix}C {1}^{′} \\ C {2}^{′} \\ C {3}^{′}\end{matrix} ] = E \cdot [ \begin{matrix}C 1 \\ C 2 \\ C 3\end{matrix} ] = [ \begin{matrix}1 + s & - s / 2 & - s / 2 \\ - s / 2 & 1 + s & - s / 2 \\ - s / 2 & - s / 2 & 1 + 2\end{matrix} ] \cdot [ \begin{matrix}C 1 \\ C 2 \\ C 3\end{matrix} ] \qquad ( 2 )$$

According to equation (2), C1′, C2′, C3′ are respectively expressed below:

C1=(1+s)C1+(−s/2)C2+(−s/2)C3 (3.1)

C2′=(−s/2)C1+(1+s)C2+(−s/2)C3 (3.2)

C3′=(−s/2)C1+(−s/2)C2+(1+s)C3 (3.3)

The original pixel data (C1, C2, C3) is equal to (18, 165, 80). By substituting the scale factor s in equations (3.1), (3.2) and (3.3) with 0.10, C1′, C2′, and C3′ are approximately equal to 8, 177, and 79. Compared with the original pixel data (18, 165, 80), the grayscale value C2′ in the processed pixel data is increased and both the grayscale value C1′ and the grayscale value C3′ are decreased. This implies that the green color in the processed pixel is enhanced compared with that of the original pixel.

Despite the proportion of each color in a pixel is changed, the hue of the image after being processed according to the above algorithm remains the same. Let the color grayscale values of the red, the green and the blue data before the pixel is adjusted have the following relationship: C1>C2>C3, and let the original hue of the pixel be H, then the relationship among the color grayscale values of the red, the green and the blue data after the pixel is adjusted according to the algorithm is C1′>C2′>C3′, and the hue of the processed pixel is H′, wherein:

$$\begin{matrix}H = 60 ° \times \frac{C 2 - C 3}{C 1 - C 3} & ( 4.1 ) \\ {H}^{′} = 60 ° \times \frac{C {2}^{′} - C {3}^{′}}{C {1}^{′} - C {3}^{′}} & ( 4.2 )\end{matrix}$$

Equations (4.1) and (4.2) are the expressions of the hue of conventional HSV color space. By introducing equations (3.1), (3.2) and (3.3) to equation (4.2), the equation (4.2) is rearranged as:

$$\begin{matrix}{H}^{′} = 60 ° \times \frac{C {2}^{′} - C {3}^{′}}{C {1}^{′} - C {3}^{′}} \\ = 60 ° \times \frac{\begin{matrix}[ ( - s / 2 ) C 1 + ( 1 + s ) C 2 + ( - s / 2 ) C 3 ] - \\ [ ( - s / 2 ) C 1 + ( - s / 2 ) C 2 + ( 1 + s ) C 3 ]\end{matrix}}{\begin{matrix}[ ( 1 + s ) C 1 + ( - s / 2 ) C 2 + ( - s / 2 ) C 3 ] - \\ [ ( - s / 2 ) C 1 + ( - s / 2 ) C 2 + ( 1 + s ) C 3 ]\end{matrix}} \\ = 60 ° \times \frac{( 1 + 3 s / 2 ) C 2 - ( 1 + 3 s / 2 ) C 3}{( 1 + 3 s / 2 ) C 1 - ( 1 + 3 s / 2 ) C 3} \\ = 60 ° \times \frac{C 2 - C 3}{C 1 - C 3} \\ = H\end{matrix} \qquad$$

According to the above calculation, the hue for the pixel remains the same before and after adjustment.

As indicated in FIG. 1, the image processing method further comprises step 14: a processed image is outputted according to the processed pixel data. Refer to Appended Drawings 1A, 1B, 2A, and 2B. Appended Drawing 1A is a first color image. Appended Drawing 1B is a CIE 1931 chromaticity coordinate distribution diagram of the image of Appended Drawing 1A. Appended Drawing 2A is an adjusted image of the first color image of Appended Drawing 1A after image processing. Appended Drawing 2B is a CIE 1931 chromaticity coordinate distribution diagram of the image of Appended Drawing 2A. As shown in Appended Drawings 1B and 2B, after the image is processed, the coordinates of the pixels of the first color image expand outwardly from the range of chromaticity distribution. This implies that the color saturations of different pixels are increased.

Refer to Appended Drawings 3A, 3B, 4A, and 4B. Appended Drawing 3A is a second color image. Appended Drawing 3B is a CIE 1931 chromaticity coordinate distribution diagram of Appended Drawing 3A. Appended Drawing 4A is an adjusted image of the second color image of Appended Drawing 3A after image processing. Appended Drawing 4B is a CIE 1931 chromaticity coordinate distribution diagram of the image of Appended Drawing 4A. As shown in Appended Drawings 3B and 4B, after the image is processed, the coordinates of the pixels of the second color image shifts towards the boundary of the range of chromaticity distribution. Appended Drawings 1A to 4B give the evidence that the image processing method in the embodiment indeed enhances the color saturation of the image.

As pixels of an image are processed one by one, there is no need to use any additional frame memory. It is particularly applicable to a portable display device such as mobile communication device or PDA for lowering the cost.

Compared with the U.S. Pat. No. 6,771,311 entitled “Automatic Color Saturation Enhancement”, the invention processes a single pixel of an image at a time, hence largely decreasing the complexity of operation and effectively reducing the complexity of the embodiment of hardware.

Compared with the U.S. Pat. No. 6,721,000 entitled “Adaptive Pixel-Level Color Enhancement For A Digital Camera”, the invention enhances the pixel with small color purity more largely than the pixel with greater color purity, hence avoiding the occurrence of clipping.

Compared with the paper entitled “More Realistic Colors From Small-Gamut Mobile Displays” presented by the Philips Research Laboratories in the SID 2004, the invention effectively enhances the color saturation of the image without having to look for the maximum value and the minimum value of a whole image or having to perform complicated operations, hence reducing the complexity of the embodiment of the hardware.

According to the image processing method disclosed in the above embodiment of the invention, the color saturation of an image could be enhanced by processing single pixel of the image at a time. Firstly, the pixel data of the single pixel is inputted and calculated to obtain the color purity of the pixel. Then, the scale factor of the pixel is determined according to the color purity, and the enhancement matrix of the pixel is generated. The grayscale values of three colors of the pixel are then adjusted according to the pixel data and the enhancement matrix. The method effectively avoids the occurrence of clipping and meets the requirement of displaying images with high quality.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing method for enhancing the color saturation of an image, wherein the image includes at least a pixel with a pixel data having three colors data, the image processing method comprises:
(a) calculating a color purity of the pixel, wherein the color purity is the difference between the maximum grayscale value and the minimum grayscale value of the three colors data, and a scale factor is generated according to the color purity; and
(b) determining an enhancement matrix of the pixel according to the scale factor, and generating a processed pixel data according to the enhancement matrix and the pixel data.

2. The image processing method according to claim 1, wherein the color purity has a plurality of scales.

3. The image processing method according to claim 1, wherein the step (a) further comprises:
(a1) providing a Query Table for determining the scale factor according to the color purity.

4. The image processing method according to claim 3, wherein the Query Table comprises a plurality of numeric pairs each having a lower limit and a factor corresponding to the lower limit.

5. The image processing method according to claim 4, wherein the numeric pairs at least comprise a first numeric pair and a second numeric pair, the first numeric pair comprises a first lower limit and a first factor, the second numeric pair comprises a second lower limit and a second factor, the first lower limit is greater than the second lower limit, and the first factor is smaller than the second factor.

6. The image processing method according to claim 5, wherein the step (a1) further comprises:
(a11) determining whether the color purity is greater than or equal to the first lower limit, and if the color purity is greater than or equal to the first lower limit, the scale factor is the first factor.

7. The image processing method according to claim 6, wherein if the color purity is smaller than the first lower limit, the step (a1) further comprises:
(a12) determining whether the color purity is greater than or equal to a lower limit of the next numeric pair, if the color purity is greater than or equal to the lower limit of the next numeric pair, the scale factor is a factor of the next numeric pair; and
(a13) repeating step (a12) until the scale factor is obtained.

8. The image processing method according to claim 1, wherein the three colors are red, green and blue.

9. The image processing method according to claim 1, wherein the processed pixel data comprises another three colors data, the grayscale values of the three colors are C1, C2 and C3, another grayscale values of the three colors are C1′, C2′ and C3′, the scale factor value is s, and according to the enhancement matrix, C1′, C2′ and C3′ are respectively expressed as:
C1′=(1+s)×C1+(−s/2)×C2+(−s/2)×C3,
C2′=(−s/2)×C1+(1+s)×C2+(−s/2)×C3, and
C3′=(−s/2)×C1+(−s/2)×C2+(1+s)×C3.

10. The image processing method according to claim 9, wherein the three colors are red, green and blue.

11. The image processing method according to claim 1, further comprises:
outputting a processed image according to the processed pixel data.
